(19) United States
(12) Patent Application Publication
(10) Pub. No.: US 2008/0116594 A1
(43) Pub. Date: May 22, 2008

(54) Mechanical Air Fuel Ratio Regulating Carburettor with Fuel Pressure Regulation

(76) Inventor: Anthony John Williams, Mijdrecht (NL)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/722,591

(22) PCT Filed: Aug. 18, 2005
(86) PCT No.: PCT/NL05/00598

§ 371 Date: Jun. 22, 2007

(30) Foreign Application Priority Data
Aug. 31, 2004 (NL) 1026934
Dec. 22, 2004 (NL) 1027853

(51) Int. Cl. F02M 19/08

(52) U.S. Cl. 261/78.1; 261/38

(57) ABSTRACT

Described is a carburetor (8), comprising an air (2) inlet with a mechanically adjustable air valve (3), an into the air inlet coming mechanically adjustable atomiser, and a mechanical metering device connected with the air valve and the atomiser, maintaining a stoichiometric ratio between amounts of air and fuel. Furthermore the carburetor has fuel pressure regulating means/devices (13) that are equipped to influence the fuel pressure, in dependence of one or more dynamic engine load parameters, under which the vacuum signal in the air inlet, which is obtained via a vacuum intake conduit (12) coming into the air inlet (2). By regulating the fuel pressure also in dependence of the measured vacuum signal, the emission of unburned fuel is reduced under certain dynamic conditions of the combustion engine.

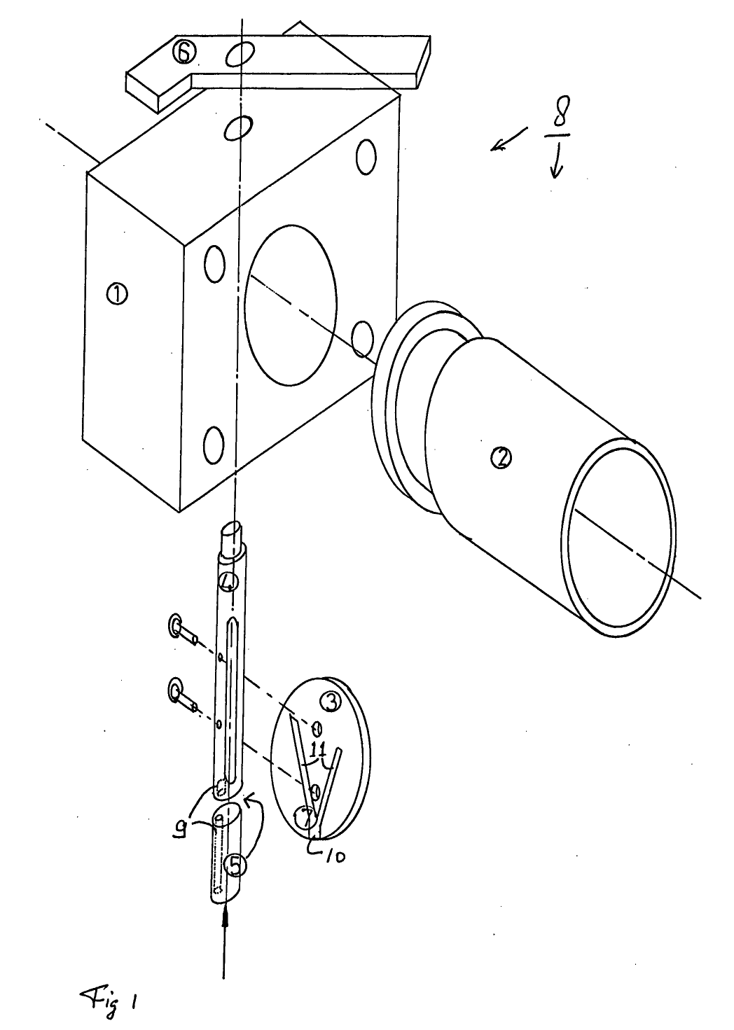

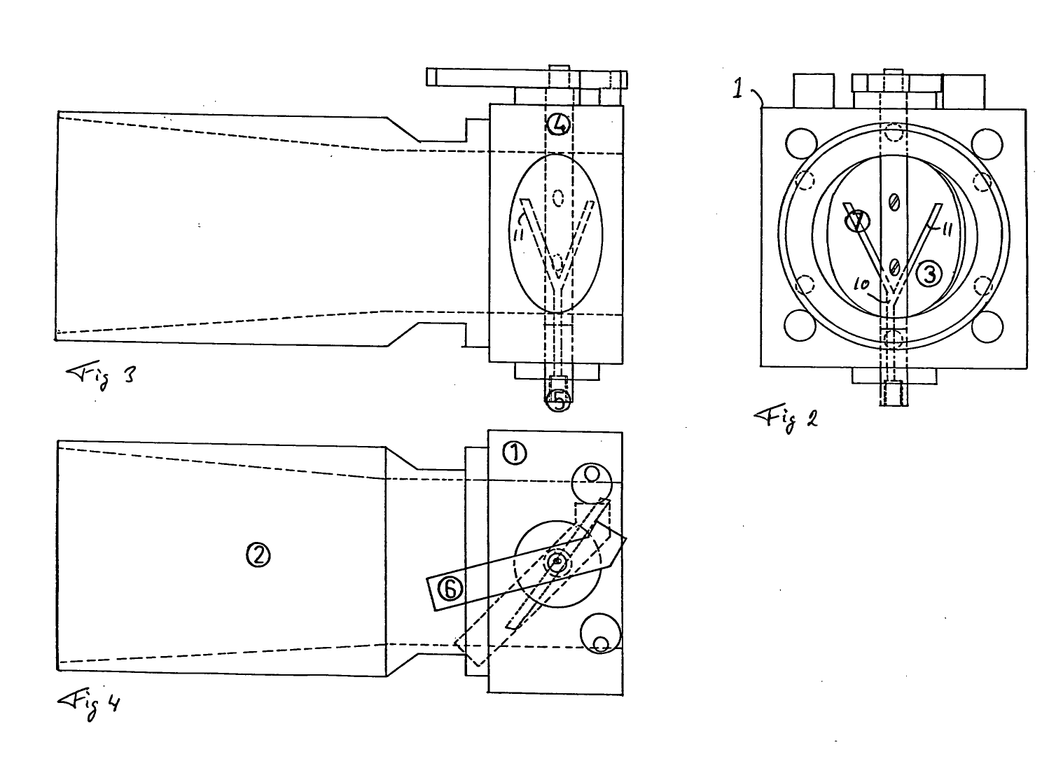

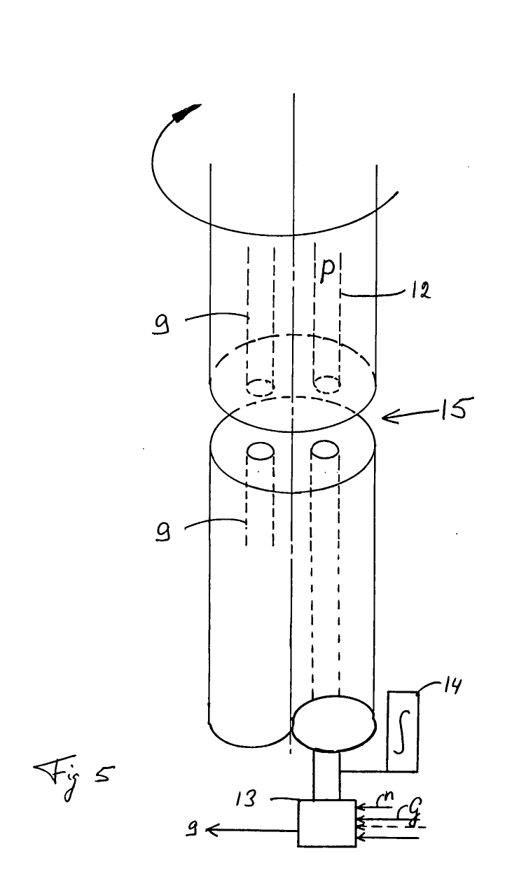

The invention relates to a carburetor comprising an air inlet with a mechanically adjustable air valve, an atomiser coming into the air inlet, a metering device with the air valve and atomiser connected, often partly electronically made.

The invention also relates to a fuel engine, which is equipped with such a carburetor, on a vehicle equipped with the combustion engine and to a method whereby fuel is injected into the air inlet.

Such a carburetor and fuel engine are commonly known. Known are amongst others carburetors for combustion engines with a great diversity of possible applications, and mostly based on the two or four-stroke principle. As for applications one can roughly think of traction or industrial applications, varying from small to large capacities. The application depending design of the carburetor is then always a compromise between price, performance and for example manageability, maintenance, number of parts, vulnerability and such. Every application demands its own design of the carburetor, so that there is no question of exchangeability of a once made carburetor. Depending on the demanded application of the carburetor and the engine that goes with it, it is common to include a continuous increasing number of parameters in regulating the burning/combustion process of fuel and air, in an attempt to optimise this process per individual application.

This makes the known carburetor and the thereby belonging mostly process operated devices more and more complex, reduces their exchangeability, increases the dependence of the necessary maintenance of the great number of parts, works price increasing, and reduces also the overall reliability.

Aim of the invention is to provide a better, easy to make carburetor, with more universal application possibilities, which are less vulnerable and still regulate under all working conditions the right amounts of fuel air.

To this end the carburetor according to the invention has an air inlet with a mechanically adjustable air valve, a mechanically adjustable atomiser coming into the air inlet, and a mechanical metering device connected with the air-valve and the atomiser, maintaining a stoichiometric ratio between amounts of air and fuel.

The invention is based on the belief that not more parts and process parameters in the regulating should be taken in, but that to increase the efficiency of the burning of the fuel, the volumetric efficiency needs to be improved, so that under all working conditions sufficient air is available within the complete reach of the engine, in which the carburetor is used. This according to the invention is obtained by placing a direct, mechanical, metering device between the mechanical adjustable air valve and atomiser for the fuel that—once set—maintains a fixed stoichiometric ratio between the amounts air and fuel. In this way, or via this method, the available engine capacity for combustion can be used more effectively than before, for the benefit of creating or generating an increased brake mean effective pressure and thereby increased torque.

The carburetor according to the invention, with its reduced component parts is therefore simplified, has become more reliable and as a consequence of the reduction of the number of moving parts, there is less maintenance required on the carburetor, according to the invention.

In an embodiment the metering device, which is exclusively a mechanically equipped metering device, is incorporated in the air inlet, through which the carburetor, according to the invention, also becomes more compact.

According to a differentiation of such a concept, the spindle around which the air valve turns is made multiparted and hollow, as specified in the subclaims, thus a very simple design of the carburetor according to the invention is realised.

A further preferred embodiment is characterised in that the atomiser comes into the air inlet at the foot of the air valve. This has the advantage that the fuel is led into such a position in the air inlet that a perfectly homogeneous atomisation takes place.

Another embodiment of the carburetor, according to the invention is characterised in that the air valve has from the foot, and over the surface of the air valve, grooves. The fuel atomises uniformly from the grooves, thus also an optimum mixture takes place of fuel and air.

Further the invention relates to a combustion engine and to a vehicle which is equipped with the above mentioned carburetor. Such an engine can take all known types of fuel, such as petrol, gas, diesel and any hydrocarbon compound.

Also the invention, in further detail, relates to a fuel injection method which is characterised in that the fuel pressure of the fuel injected into the air inlet is regulated and positive or negative changes in the air inlet are measured and are taken as a measure to regulate the fuel pressure, whereby, in a differentiation of this, the change at the exit point of fuel in the air inlet is measured.

The method, according to the invention, provides the possibilities under certain dynamic conditions of the combustion engine in a vehicle, in which for example, a lot of unburned fuel is emitted, to modulate the fuel pressure, more specifically to reduce it, and therefore reduce the harmful emissions.

Now, namely the carburetor, the combustion engine and the fuel injection method of the invention will be further explained, with the aid of the below illustrations, in which similar parts are encircled with reference numbers.

Illustration 1 is a description/drawing of the carburetor according to the invention.

Illustrations 2, 3 and 4 are drawings of right, back and top of the carburetor from illustration 1.

Illustration 5 is a detail of a multiparted spindle which is equipped with a fuel conduit and a vacuum-intake conduit and which is suitable for application in the carburetor according to the illustrations 1-4.

The illustrations 1, 2, 3 and 4 show a valve block 1, an air inlet 2, in which situated an air valve 3, which is turnable around a multiparted spindle 4, which is part of a mechanical metering device, a fuel valve 5, which is situated on the partition surface, which serves as metering device, on the multiparted spindle 4, a lever 6 connected on the top part of the spindles 4, and grooves 7, which can be engraved on the surface of the air valve 3. The parts 1-7 form the main parts of a schematically presented carburetor 8, which as so far is presented in this execution/design, is purely mechanical. Through the fixed mechanical coupling, in the form of the “still to be explained” or “yet to be defined”, metering device 4, in all pressure situations and applications, at each with the lever 6 set position of the fuel valve 5, a stoichiometric ratio between the amounts air and fuel is maintained. The illustrated carburetor 8 assures with a near unobstructed flow of air through the air inlet 2, then, at all times, for an optimum volumetric efficiency, through which, without further necessary accessories, under all dynamic conditions, a better efficiency is obtained.

The metering device concentrates around the air inlet 2 incorporated multifunctional spindle 4, whereby the air valve 3 is fitted in the upper turnable spindle part of illustration 1. The moveable upper spindle part forms with the lower fixed spindle part from illustration 1, the fuel regulating valve 5, in a fuel conduit 9, which goes partly through the hollow parts of the spindle 4. The amount of fuel which is let in, through the valve 5, into the air inlet 2, is therefore, via the angular position of the spindle 4, and the air valve 3, precisely, stoichiometrically related to the amount of air that passes the valve 3. The fuel conduit, with a desired diameter 9 will therefore be mostly eccentric in the respective spindle parts of the multiparted spindle 4.

The part of the fuel conduit 9 situated in the upper spindle part of the multiparted spindle 4, comes into the air inlet 2, at the foot 10, of the air valve 3. The air valve 3, from the foot 10, over the surface of the air valve 3, can have grooves 11, through which an homogenous mixture of fuel and air comes about, which atomised uniformly, can be guided, via the air inlet 2, to the engine.

The described method, can simply be combined with methods to vary the pressure of the fuel to the fuel valve 5, if desired in dependence of one or more thermodynamic engine pressure parameters. Fine tuning of parameters, such as, for example the fuel pressure, and/or the fuel volume can subsequently take place, with the aid of vacuum, hydraulic, pneumatic, or suitable mechanics.

Practical advantage, is the absence of a fuel reservoir in the carburetor 8, and therefore the absence of a float and needle, which has as a further positive result that the carburetor 8 can be placed and used in any desired position, vertical, upside down, or on its side. Therefore, problems in relation to that construction, are undermined. One can think of the problem of shortage of fuel at the occurrence of large G-forces, such as occur, in racing with a wide variation of dynamic forces. But also a possibility that too much fuel which can also be the consequence of such big G-forces. Also, there are no longer problems with floats and needles or evaporation of fuel (dampslot) on the spot which is caused by high temperatures in the combustion space, and the engine, halted.

If desired, mostly depending on the load process and the application of the engine in question, several carburetors 8 can be connected parallel to one another to provide one or more combustion spaces with the desired fuel air mixture.

Illustration 5 shows the multifunctional spindle 4, which, in this variant, is equipped with two conduits, these are the fuel conduit 9 and a vacuum intake conduit 12. In a preference design the above mentioned schematically presented in illustration 5 fuel pressure regulating means/devices 13 equipped to regulate the fuel pressure of the injected fuel in the air inlet 2. More particular, the fuel pressure is influenced in dependence of the pressure P in the air inlet 2, more specifically, through measuring that pressure, via the vacuum intake conduit 12. The vacuum intake conduit 12 comes into the air inlet 2, preferably in the proximity of the exit point of the fuel into the air stream. By this method the fuel pressure can be adapted by the means/devices 13 to the dynamic conditions of the combustion engine. If, for example, a driver in a high gear G in a car, with low engine speed n, gives a lot of gas, a great amount of unburned hydrocarbons from the fuel, will go via the exhaust into the environment. This will stay the case, until the engine has developed sufficient speed to totally atomise the fuel present in the venturi, and then to burn the fuel air mixture. By limiting (in this case by low engine speed n, in particular at a high gear G, the fuel pressure), the undesired emission is stopped.

In general under all dynamic conditions, the fuel pressure regulation, can, with the right metering information, for the fuel pressure regulating devices 13, as additional trimming device, be used, to obtain as “perfect” as possible complete combustion.

Additionally, the carburetor 8, can be equipped with a fuel damping/delay valve 14, mostly in the vacuum intake conduit. The fuel damping/delay valve 14 assures that small pressure variations in the venturi, which, via the intake conduit 12, in the air inlet, are being measured, are being smoothed, and so to speak, are being mathematically integrated, by which also a desired delay time in the fuel pressure regulating/metering is introduced.

In illustration 5, the fuel valve controls the fuel supply via the fuel conduit 9, as earlier explained. If so wished, a measure, for the fuel supply via the valve 5, can also be given to the pressure in the intake conduit 12. The diameter of the conduit 12 can, to this purpose, be made parabolic, by making this, for example elliptic, or bring in another suitable shape of the diameter on the spot of the partition surface 15 of the fuel valve 5, between the (to be more clear, drawn here at a distance from each other), spindle parts of the spindle 4.

The fuel pressure regulation can, if desired, also independently from the specific carburetor design with multipartite spindle 4 and/or conduits 9 and 12, be applied. Also, a form of gravity, or movement force guided fuel pressure regulation, can take place, or the fuel can be sucked via underpressure.

The carburetor can be made, at least partly for example, through moulding in plastic or aluminium.

1. A carburetor comprising an air inlet with a mechanically adjustable air valve, a mechanically adjustable atomiser discharging in the air inlet, and a mechanical metering device coupled with the air valve and the atomiser, which device maintains a stoichiometric ratio between amounts air and fuel.

2. Carburetor according to claim 1, characterised in that the metering device is a solely mechanically equipped metering device.

3. Carburetor according to claim 1 or 2, characterised in that the metering device is included in the air inlet.

4. Carburetor according to one of the claims 1-3, characterised in that the metering device comprises a multipartite spindle, whereby the air valve is pivotable around one spindle part.

5. Carburetor according to claim 4, characterised in that the multipartite spindle is provided with a fuel conduit leading to the atomiser.

6. Carburetor according to claim 4 or 5, characterised in that the multipartite spindle has spindle parts which are mutually rotatable.

7. Carburetor according to one of the claims 4-6, characterised in that the amount of fuel through the fuel conduit of the multipartite spindle to the atomiser is controllable by rotating the one spindle part, in proportion with the amount of air allowed to pass, relative to the other spindle part.

8. Carburetor according to one of the claims 4-7, characterised in that the fuel conduit is situated eccentric in the respective spindle parts of the multipartite spindle.

9. Carburetor according to one of the claims 4-8, characterised in that one of the spindle parts is fixedly mounted in the carburetor.

10. Carburetor according to one of the claims 4-9, characterised in that the atomiser discharges into the air inlet at the foot of the air valve.

11. Carburetor according to claim 10, characterised in that the air valve has grooves extending from the foot over the surface of the air valve.

12. Carburetor according to one of claims 1-11, characterised in that the carburetor comprises fuel pressure regulating means connected to the fuel valve.

13. Carburetor according to claim 12, characterised in that the fuel pressure regulating means are equipped to influence the fuel pressure, also in dependence of one or more combustion—or engine load/pressure parameters among which is the vacuum pressure in the air inlet.

14. Carburetor according to claim 2 or 13, characterised in that the carburetor has a vacuum sensing conduit, discharging into the air inlet.

15. Carburetor according to one of the claims 1-14, characterised in that the metering device comprises a multipartite spindle which is provided with a vacuum sensing conduit leading to the air inlet.

16. Carburetor according to claim 14 or 15, characterised in that the carburetor is provided with a flow damping/delay valve connected to the vacuum intake conduit.

17. Carburetor according to one of the previous claims, characterised in that the metering device comprises of a multipartite spindle whereby the air valve around one spindle part is made turnable, and that the multipartite spindle is equipped with a fuel conduit leading to the atomiser, and/or with a vacuum sensing conduit leading to the air inlet, and has spindle parts that between themselves are turnable.

18. A combustion engine equipped with a carburetor according to one of the claims 1-17, characterised in that the carburetor comprises: an air inlet with a mechanical adjustable air valve, a mechanically adjustable atomiser discharging into the air inlet, and a mechanical metering device connected with the air valve and the atomiser and maintaining a stoichiometric ratio between amounts of air and fuel.

19. A vehicle equipped with a combustion engine according to claim 18.

20. A method whereby fuel is injected into an air inlet, characterised in that the fuel pressure of the injected fuel, is being regulated, and pressure in the air inlet is being measured, and taken as a measure, to regulate the fuel pressure.

21. Method according to claim 20, characterised in that the pressure on the point of exit of the fuel into the air inlet is measured.
